(19) United States
(12) Patent Application Publication
(10) Pub. No.: US 2019/0095093 A1
(43) Pub. Date: Mar. 28, 2019

(54) INFORMATION PROCESSING APPARATUS, INFORMATION PROCESSING METHOD, AND COMPUTER READABLE MEDIUM

(71) Applicant: MITSUBISHI ELECTRIC CORPORATION, Tokyo (JP)

(72) Inventors: Atsushi HORI, Tokyo (JP); Yuichi SASAKI, Tokyo (JP); Hiroyasu NEGISHI, Tokyo (JP); Kentaro MORI, Tokyo (JP); Akira TORII, Tokyo (JP); Takuya MAEKAWA, Tokyo (JP); Toshiyuki HAGIWARA, Tokyo (JP)

(73) Assignee: MITSUBISHI ELECTRIC CORPORATION, Tokyo (JP)

(21) Appl. No.: 16/085,958

(22) PCT Filed: Apr. 28, 2016
(86) PCT No.: PCT/JP2016/063470

§ 371 Date: Sep. 17, 2018

(51) Int. Cl. G06F 3/0488; G06F 3/0484

(52) U.S. Cl. CPC G06F 3/04883; G06F 3/04847

(57) ABSTRACT

A gesture determination unit (143) extracts a moving locus of a pointer from a time when the pointer makes contact with the touch panel until the pointer goes away from the touch panel. Then, the gesture determination unit (143) identifies a control target parameter, which is a parameter of a control target, and a controlled variable of the control target parameter that are specified by a movement of the pointer, by analyzing the extracted moving locus of the pointer.

### TECHNICAL FIELD

The present invention relates to an information processing apparatus which includes a touch panel.

### BACKGROUND ART

An information input apparatus capable of so-called blind inputs is disclosed in Patent Literature 1. According to the technique of Patent Literature 1, a user can perform inputs without concern for the orientation for the information input apparatus while not viewing display of operation keys on an operation region (touch panel) of the information input apparatus, for example, while keeping the information input apparatus in a pocket.

### CITATION LIST

### Patent Literature

Patent Literature 1: JP 2009-140210

### SUMMARY OF INVENTION

### Technical Problem

In the technique of Patent Literature 1, the information input apparatus arranges the operation keys on the touch panel correspondingly to the direction and orientation in which the user slides his or her finger on the touch panel. And, in the technique of Patent Literature 1, when the user remembers the layout of the operation keys, the user performs inputs to the information input apparatus by operating the operation keys without viewing the operation keys.

In the technique of Patent Literature 1, the user is required to perform a slide operation for arranging the operation keys on the touch panel and operate the operation keys after the operation keys are arranged on the touch panel by the slide operation.

Information devices typified by smartphones can perform, via wireless communication, control of the sound volume of a television set, control of screen luminance of a television set, control of air quantity of an air conditioner, control of illuminance of illumination, and so forth.

When the user tries to perform these controls by using the technique of Patent Literature 1, the user is required to perform a slide operation for arranging the operation keys on the touch panel, perform an operation for specifying a parameter of a control target (for example, the sound volume of a television set), and perform an operation for specifying a controlled variable (an amount of increase or an amount of decrease) of the parameter of the control target.

In this manner, the information input apparatus of Patent Literature 1 has a problem of a trouble in which the user has to perform a plurality of touch panel operations before one control is performed.

One of main objects of the present invention is to solve this problem, and the present invention mainly aims to improve convenience in touch panel operation.

### Solution to Problem

An information processing apparatus including a touch panel, includes:

an extraction unit to extract a moving locus of a pointer from a time when the pointer makes contact with the touch panel until the pointer goes away from the touch panel; and

an identification unit to identify a control target parameter, which is a parameter of a control target, and a controlled variable of the control target parameter that are specified by a movement of the pointer, by analyzing the moving locus of the pointer extracted by the extraction unit.

### Advantageous Effects of Invention

In the present invention, a moving locus of the pointer from a time when the pointer makes contact with the touch panel until the pointer goes away from the touch panel is analyzed, and a control target parameter, which is a parameter of a control target, and a controlled variable of the control target parameter are identified. Thus, according to the present invention, the user can specify a control target parameter and a controlled variable with one touch panel operation, and convenience in touch panel operation can be improved.

### BRIEF DESCRIPTION OF DRAWINGS

FIG. 1 illustrates a hardware configuration example of a portable device and a control target device according to Embodiment 1.

FIG. 2 illustrates a functional configuration example of the portable device according to Embodiment 1.

FIG. 3 illustrates an example of gesture operation according to Embodiment 1.

FIG. 4 illustrates an example of gesture operation according to Embodiment 1.

FIG. 5 illustrates an example of gesture operation according to Embodiment 2.

FIG. 6 illustrates a rotation gesture operation and the center of a circle according to Embodiment 3.

FIG. 7 illustrates an example of gesture operation according to Embodiment 6.

FIG. 8 illustrates an example of gesture operation according to Embodiment 6.

FIG. 9 illustrates an example of gesture operation according to Embodiment 6.

FIG. 10 illustrates an example of gesture operation according to Embodiment 7.

FIG. 11 illustrates an example of gesture operation according to Embodiment 7.

FIG. 12 illustrates an example of gesture operation according to Embodiment 8.

FIG. 13 illustrates an example of gesture operation according to Embodiment 8.

FIG. 14 illustrates an example of gesture operation according to Embodiment 8.

FIG. 15 illustrates an example of gesture operation according to Embodiment 9.

FIG. 16 illustrates an example of gesture operation according to Embodiment 9.

FIG. 17 illustrates an example of gesture operation according to Embodiment 10.

FIG. 18 illustrates an example of gesture operation according to Embodiment 10.

FIG. 19 illustrates an example of a distorted circle according to Embodiment 4.

FIG. 20 illustrates an example in which a vertical direction is decided by using information from a gravity sensor according to Embodiment 11.

FIG. 21 is a flowchart illustrating an operation example of the portable device according to Embodiment 1.

### DESCRIPTION OF EMBODIMENTS

### Embodiment 1

***Description of Configuration***

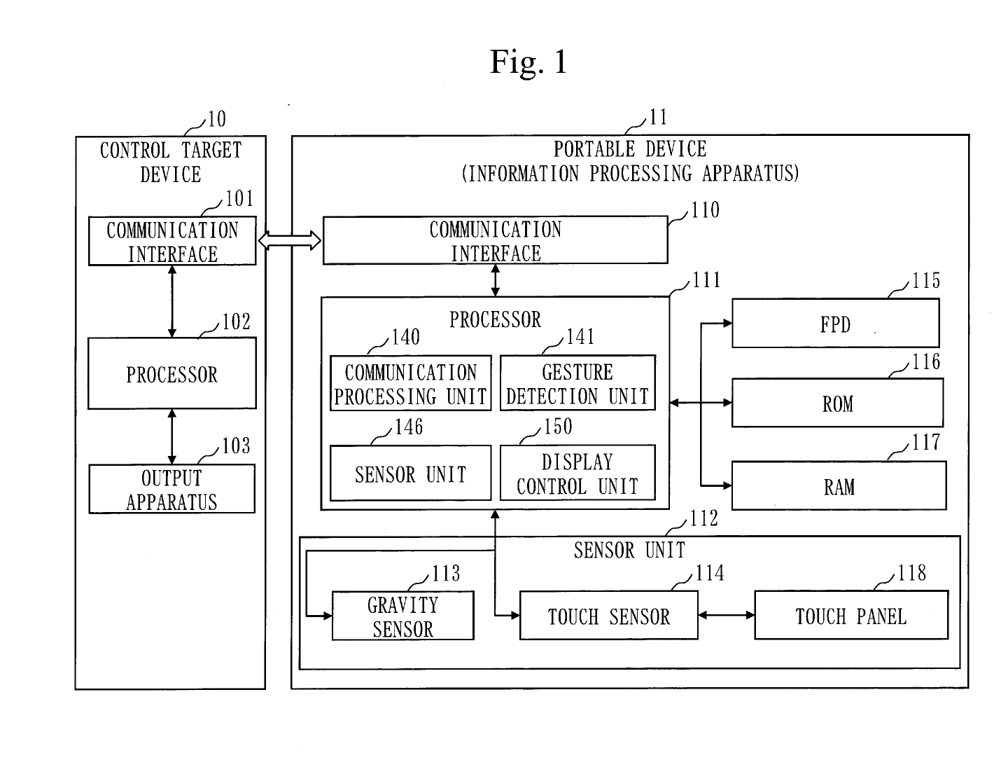

FIG. 1 illustrates a hardware configuration example of a portable device 11 and a control target device 10 according to Embodiment 1.

The portable device 11 controls the control target device 10 by following an instruction from a user.

The portable device 11 is, for example, a smartphone, tablet terminal, personal computer, or the like.

The portable device 11 is an example of an information processing apparatus. Also, an operation performed by the portable device 11 is an example of an information processing method.

The control target device 10 is a device to be controlled by the portable device 11.

The control target device 10 is a television set, air conditioner, illumination system, or the like.

The portable device 11 is a computer which includes a communication interface 110, a processor 111, a FPD (Flat Panel Display) 115, a ROM (Read Only Memory) 116, a RAM (Random Access Memory) 117, and a sensor unit 112.

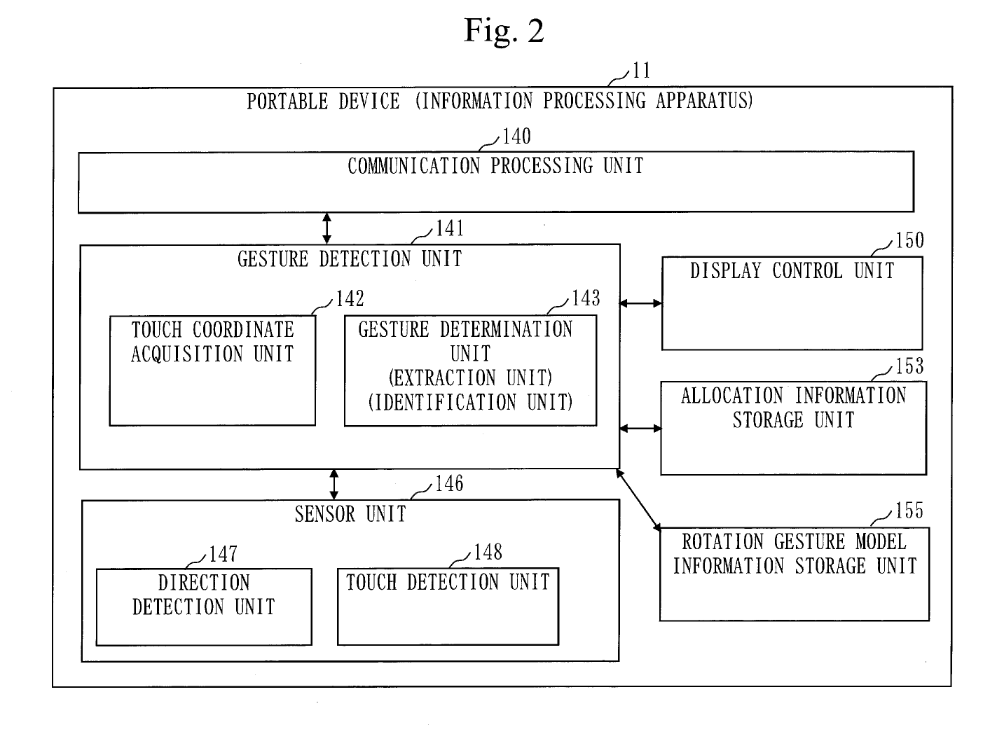

The ROM 116 stores a program for realizing functions of a communication processing unit 140, a gesture detection unit 141, a sensor unit 146, and a display control unit 150 illustrated in FIG. 2. This program is loaded to the RAM 117 and is executed by the processor 111. FIG. 1 schematically represents a state in which the processor 111 is executing the program for realizing the functions of the communication processing unit 140, the gesture detection unit 141, the sensor unit 146, and the display control unit 150. Note that this program is an example of an information processing program.

Also, the ROM 116 realizes an allocation information storage unit 153 and a rotation gesture model information storage unit 155 illustrated in FIG. 2.

The communication interface 110 is a circuit for performing wireless communication with the control target device 10.

The FPD 115 displays information to be presented to the user.

The sensor unit 112 includes a gravity sensor 113, a touch sensor 114, and a touch panel 118.

The control target device 10 includes a communication interface 101, a processor 102, and an output apparatus 103.

The communication interface 101 is a circuit for performing wireless communication with the portable device 11.

The processor 102 controls the communication interface 101 and the output apparatus 103.

The output apparatus 103 differs for each control target device 10. If the control target device 10 is a television set, the output apparatus 103 is a loudspeaker or a FPD. If the control target device 10 is an air conditioner, the output apparatus 103 is an air blowing mechanism. If the control target device 10 is an illumination system, the output apparatus 103 is an illumination device.

FIG. 2 illustrates a functional configuration example of the portable device 11 according to the present embodiment.

As illustrated in FIG. 2, the portable device 11 is configured of the communication processing unit 140, the gesture detection unit 141, the sensor unit 146, the display control unit 150, the allocation information storage unit 153, and the rotation gesture model information storage unit 155.

The communication processing unit 140 communicates with the control target device 11 by using the communication interface 114 illustrated in FIG. 1. More specifically, the communication processing unit 140 transmits a control command generated by a gesture determination unit 143, which will be described further below, to the control target device 10.

The sensor unit 146 includes a direction detection unit 147 and a touch detection unit 148.

The direction detection unit 147 detects a direction of the portable device 11. Details of the direction detection unit 147 will be described in Embodiment 11.

The touch detection unit 148 acquires touch coordinates touched by a pointer. The pointer is a user's finger or a touch pen used by the user. Also, the touch coordinates are coordinates on the touch panel 118 which have been touched by the pointer.

The gesture detection unit 141 includes a touch coordinate acquisition unit 142 and the gesture determination unit 143.

The touch coordinate acquisition unit 142 acquires touch coordinates from the sensor unit 146.

The gesture determination unit 143 identifies a gesture made by the user based on the touch coordinates acquired by the touch coordinate acquisition unit 142. That is, by successively acquiring touch coordinates, the gesture determination unit 143 extracts a moving locus of the pointer from a time when the pointer makes contact with the touch panel 118 until the pointer goes away from the touch panel 118. The gesture determination unit 143 then analyzes the extracted moving locus of the pointer, and identifies a control target parameter, which is a parameter of a control target, and a controlled variable of the control target parameter, specified by the movement of the pointer.

The control target parameter is a parameter for controlling the control target device 10. For example, if the control target device 10 is a television set, control target parameters are a sound volume, screen luminance, screen contrast, menu item, timer setting time, and so forth. Also, if the control target device 10 is an air conditioner, control target parameters are a setting temperature, setting humidity, air quantity, air direction, and so forth. Also, if the control target device 10 is an illumination system, control parameters are illuminance and so forth.

As will be described further below, from the time when the pointer makes contact with the touch panel 118 until the pointer goes away from the touch panel 118, the user successively makes two gestures. One is a gesture for specifying a control target parameter (hereinafter referred to as a parameter-specifying gesture), and the other is a gesture for specifying a controlled variable (hereinafter referred to as a controlled-variable-specifying gesture). The gesture determination unit 143 extracts, from the extracted moving locus of the pointer, a moving locus specifying a control target parameter (that is, a moving locus corresponding to a parameter-specifying gesture) as a parameter-specifying moving locus. Also, the gesture determination unit 143 extracts, from the extracted moving locus of the pointer, a moving locus specifying a controlled variable (that is, a moving locus corresponding to a controlled-variable-specifying gesture) as a controlled-variable-specifying moving locus. Then, the gesture determination unit 143 analyzes the extracted parameter-specifying moving locus to identify the control target parameter, and analyzes the extracted controlled-variable-specifying moving locus to identify the controlled variable.

Also, the gesture determination unit 143 generates a control command for notifying the control target device 10 of the identified control target parameter and controlled variable. Then, the gesture determination unit 143 transmits the generated control command via the communication processing unit 140 to the control target device 10.

The gesture determination unit 143 is an example of an extraction unit and an identification unit. Also, an operation to be performed by the gesture determination unit 143 is an example of an extraction process and an identification process.

The display control unit 150 controls GUI (Graphical User Interface) display and so forth.

The allocation information storage unit 153 stores allocation information.

In the allocation information, a plurality of moving locus patterns are described, and a control target parameter or controlled variable is defined for each moving locus pattern.

By referring to the allocation information, the gesture determination unit 143 identifies a control target parameter or controlled variable corresponding to the extracted moving locus.

A rotation gesture model information storage unit 155 stores rotation gesture model information. Details of the rotation gesture model information will be described in Embodiment 4.

***Description of Operation***

First, a general outline of operation of the portable device 11 according to the present embodiment is described.

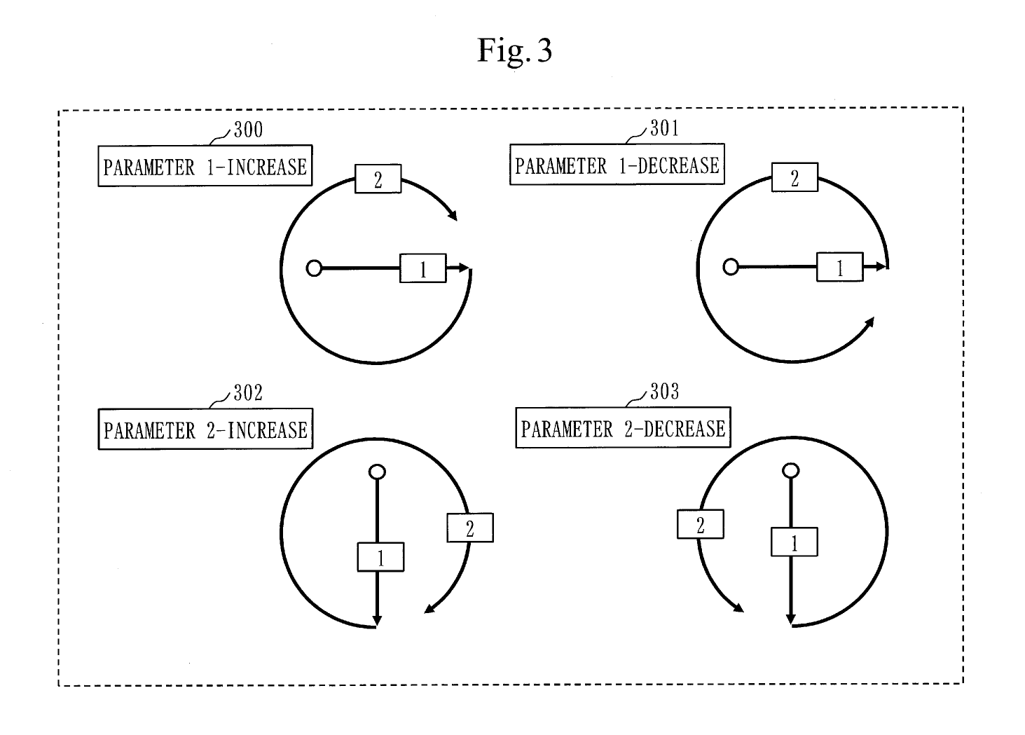

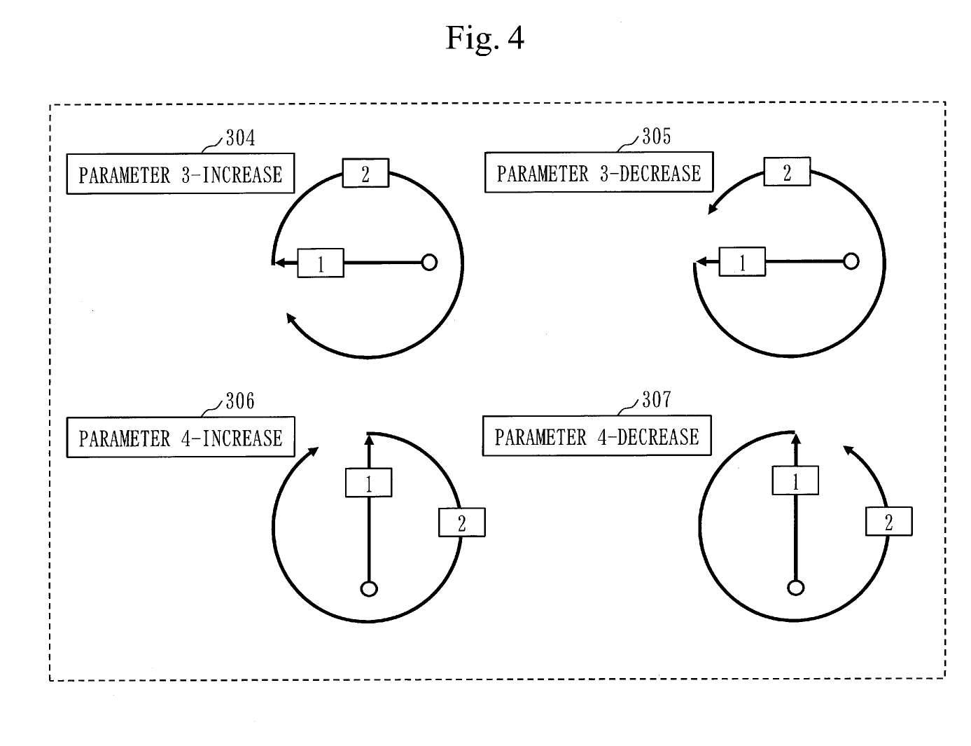

In the present embodiment, when controlling the control target device 10, the user makes a gesture illustrated in FIG. 3 and FIG. 4 to the touch panel 118.

FIG. 3 illustrates a gesture for increasing the value of a parameter 1, a gesture for decreasing the value of the parameter 1, a gesture for increasing the value of a parameter 2, and a gesture for decreasing the value of the parameter 2.

FIG. 4 illustrates a gesture for increasing the value of a parameter 3, a gesture for decreasing the value of the parameter 3, a gesture for increasing the value of a parameter 4, and a gesture for decreasing the value of the parameter 4.

The gestures illustrated in FIG. 3 and FIG. 4 include linear-movement gestures (also referred to as slide gestures) and circular-movement gestures (also referred to as rotation gestures). The linear-movement gestures are parameter-specifying gestures, and the circular-movement gestures are controlled-variable-specifying gestures.

A parameter-specifying gesture for specifying the parameter 1 is a slide gesture “moving from left to right”. A parameter-specifying gesture for specifying the parameter 2 is a slide gesture “moving from top to bottom”. A parameter-specifying gesture for specifying the parameter 3 is a slide gesture “moving from right to left”. A parameter-specifying gesture for specifying the parameter 4 is a slide gesture “moving from bottom to top”.

Also, a controlled-variable-specifying gesture for increasing the value of a parameter is a clockwise rotation gesture. Also, a controlled-variable-specifying gesture for decreasing the value of a parameter is a counterclockwise rotation gesture. The amount of increase or the amount of decrease is decided by a circulation count of the pointer. The gesture determination unit 143 analyzes the circulation direction and the circulation count of the pointer in the moving locus of the circular movement to identify the controlled variable. For example, when the user makes a clockwise rotation gesture twice, the gesture determination unit 143 identifies that the value of the parameter is increased in two steps. On the other hand, when the user makes a counterclockwise rotation gesture twice, the gesture determination unit 143 identifies that the value of the parameter is decreased in two steps.

The user makes a parameter-specifying gesture and a controlled-variable-specifying gesture with one touch panel operation. That is, the user makes a parameter-specifying gesture and a controlled-variable-specifying gesture as one gesture, from a time when the user causes the pointer to touch the touch panel 118 until the user causes the pointer to go away from the touch panel 118.

In the allocation information stored in the allocation information storage unit 153, a parameter-specifying moving locus corresponding to a parameter-specifying gesture and a controlled-variable-specifying moving locus corresponding to a controlled-variable-specifying gesture are defined for each parameter. In the allocation information, for example, for the parameter 1, a moving locus “moving from left to right” is defined as a parameter-specifying moving locus, a clockwise moving locus is defined as a controlled-variable-specifying locus for increasing the value of the parameter, and a counterclockwise moving locus is defined as a controlled-variable-specifying locus for decreasing the value of the parameter.

In FIG. 3 and FIG. 4, only linear movements in a horizontal direction (the parameter 1 and the parameter 3) and linear movements in a vertical direction (the parameter 2 and the parameter 4) are illustrated as parameter-specifying gestures. However, a parameter may be specified by a linear movement in another direction. For example, a linear movement from a 60-degree direction to a 120-degree direction, a linear movement from the 120-degree direction to the 60-degree direction, a linear movement from a 45-degree direction to a 135-degree direction, and a linear movement from the 135-degree direction to the 45-degree direction may be added as parameter-specifying gestures. This allows parameters of more types to be specified. Note herein that while a direction is represented by an angle, a parameter may be specified by an approximate direction. Also, the directions are not required to be equally divided.

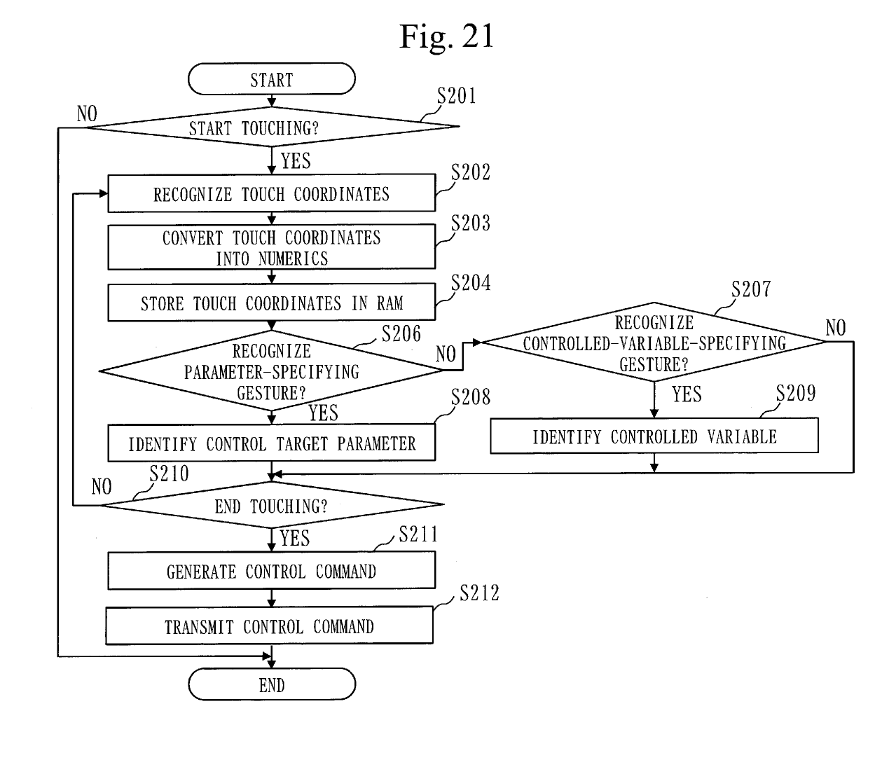

Next, with reference to a flowchart illustrated in FIG. 21, an operation example of the portable device 11 according to the present embodiment is described.

When the user starts touching the touch panel 118 (step S201), the touch detection unit 148 recognizes touch coordinates (step S202).

Then, the touch detection unit 148 converts the touch coordinates into numerics (step S203), and stores the touch coordinates converted into numerics in the RAM 117 (step S204).

Next, based on the touch coordinates stored in the RAM 117, when being able to recognize a parameter-specifying gesture (YES at step S206), that is, when extracting a parameter-specifying moving locus, the gesture determination unit 143 identifies a control target parameter (step S208). That is, the gesture determination unit 143 checks the extracted parameter-specifying moving locus against the allocation information to identify the control target parameter specified by the user. Then, parameter information indicating the identified control target parameter is stored in the RAM 117.

On the other hand, when being unable to recognize a parameter-specifying gesture (NO at step S206) and being able to recognize a controlled-variable-specifying gesture (YES at step S207), that is, when extracting a controlled-variable-specifying moving locus, the gesture determination unit 143 identifies a controlled variable (step S209). That is, the gesture determination unit 143 checks the extracted controlled-variable-specifying moving locus against the allocation information to identify the controlled variable specified by the user. Then, the gesture determination unit 143 stores controlled variable information indicating the identified controlled variable in the RAM 117.

When rotation gestures are performed a plurality of times by the user as a controlled-variable-specifying gesture, the gesture determination unit 143 generates controlled variable information with an amount of increase=1 (or an amount of decrease=1) when recognizing a rotation gesture for the first time, and stores the generated controlled variable information in the RAM 117. Thereafter, whenever recognizing a rotation gesture, the gesture determination unit 143 increments the value of the amount of increase (or the amount of decrease) of the controlled variable information by one.

Also, when the user makes a rotation gesture in a certain direction and then makes a rotation gesture in a reverse direction, the gesture determination unit 143 decrements the controlled variable of the controlled variable information so as to correspond to the circulation count of the rotation gesture in the reverse direction. For example, when a clockwise rotation gesture with “parameter 1-increase” 300 of FIG. 3 is made three times and controlled variable information with an amount of increase=3 is stored in the RAM 117 and then the user makes a counterclockwise rotation gesture with “parameter 1-decrease” 301 of FIG. 3 once, the gesture determination unit 143 decrements the value of the amount of increase to update the controlled variable information to an amount of increase=2.

Here, a scheme is described in which the gesture determination unit 143 extracts a moving locus of a linear movement in a parameter-specifying gesture.

When the successive touch coordinates outputted from the touch panel 118 and stored by the touch coordinate acquisition unit 142 in the RAM 117 fit in a specific region and move in a specific direction, the gesture determination unit 143 determines that the pointer is moving from a touch starting point to that direction. In this manner, the gesture determination unit 143 analyzes the position of the starting point and the position of the ending point of the linear movement to extract a moving locus of the linear movement and identify a control target parameter. Note that the specific region is a region in a shape such as a rectangle, elliptic arc, or triangle. The gesture determination unit 143 may use the least square method, which is a known algorithm, to extract a moving locus of the linear movement.

Next, a scheme is described in which the gesture determination unit 143 extracts a moving locus of a circular movement in a controlled-variable-specifying gesture.

When conditions that the successive touch coordinates fall in a range of a region outside and inside of double circles and successive points in a group are plotted so as to sequentially render the circles are satisfied, the gesture determination unit 143 extracts a moving locus of the circular movement. The gesture determination unit 143 can extract coordinates of the center of a circle by using a known algorithm for finding the center of a circle by extracting three points in the group of points. Also, the gesture determination unit 143 can also enhance extraction accuracy of the coordinates of the center of the circle by repeatedly executing the algorithm.

Note that the gesture determination unit 143 may remove extraneous noise by using, for example, a noise removal apparatus.

Returning to the flow of FIG. 21, when the user ends touching (YES at step S210), the gesture determination unit 143 generates a control command (step S211).

Specifically, when the touch coordinate acquisition unit 142 ceases acquisition of new touch coordinates, the gesture determination unit 143 determines that the touch by the user has ended.

The gesture determination unit 143 reads parameter information and controlled variable information from the RAM 117, and generates a control command by using the parameter information and the control information.

Then, the gesture determination unit 143 transmits the control command via the communication processing unit 140 to the control target device 10.

As a result, the control target device 10 controls the value of the control target parameter in accordance with the controlled variable.

Note that in the flow of FIG. 21, the gesture determination unit 143 generates a control command after the touch by the user ends and transmits the generated control command to the control target device 10. In place of this, the gesture determination unit 143 may generate a control command before the touch by the user ends and transmit the generated control command. The gesture determination unit 143 may transmit the control command for every break in the touch of the user. For example, the gesture determination unit 143 may transmit a control command for notification of the parameter at a stage of completion of the linear movement of FIG. 3 and transmit a control command for notification of the controlled variable for every circulation of the circular movement.

***Description of Effects of Embodiment***

As described above, according to the present embodiment, the user can specify a control target parameter and a controlled variable with one touch panel operation, and convenience in touch panel operation can be improved.

Also, the user can control the control target device 10 without viewing the screen of the portable device 11.

Also, the display control unit 150 may cause the control target parameter and the controlled variable specified by the user with a gesture to be displayed on the FPD 115 to have the user confirm the control target parameter and the controlled variable. This can improve operation accuracy.

In place of the configuration in which the display control unit 150 causes the control target parameter and the controlled variable to be displayed, the user may be notified of the control target parameter and the controlled variable by motion of a motor, sound, or the like.

Note in the above that a slide gesture is exemplarily described as a parameter-specifying gesture and a rotation gesture is exemplarily described as a controlled-variable-specifying gesture. In place of this, as a parameter-specifying gesture and a controlled-variable-specifying gesture, gestures generally used in touch panel operation may be used, such as a tap, double tap, and pinch.

### Embodiment 2

In the above-described Embodiment 1, the gesture determination unit 143 decides an amount of increase or an amount of decrease based on the circulation count of the pointer in a rotation gesture.

In the present embodiment, an example is described in which the gesture determination unit 143 identifies an amount of increase or an amount of decrease based on a circulation angle of the pointer in a rotation gesture.

That is, in the present embodiment, the gesture determination unit 143 identifies a controlled variable by analyzing a circulation direction and a circulation angle of the pointer in a circular movement with a controlled-variable-specifying moving locus.

In the present embodiment, only the operation of the gesture determination unit 143 is different compared with Embodiment 1. A hardware configuration example of the control target device 10 and the portable device 11 is as illustrated in FIG. 1, and a functional configuration example of the portable device 11 is as illustrated in FIG. 2. Also, an operation flow of the portable device 11 is as illustrated in FIG. 21.

In the following, differences from Embodiment 1 are mainly described.

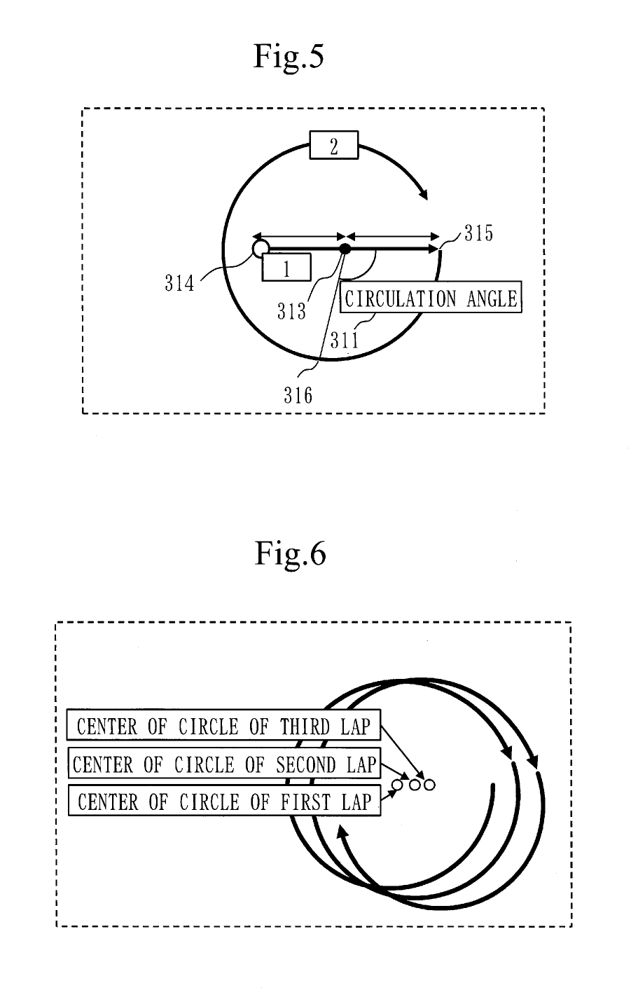

In the present embodiment, as illustrated in FIG. 5, when recognizing the operation of a horizontal movement moving from left to right in a slide gesture, which is followed by a clockwise circular movement so as to surround the moving locus of the horizontal movement, the gesture determination unit 143 identifies a controlled variable in accordance with the circulation angle of the pointer. That is, in a case where the gesture determination unit 143 recognizes a prescribed circulation angle when a clockwise circular movement occurs, the gesture determination unit 143 determines an amount of increase=1. A center position 313 for finding a circulation angle is a center position between a starting point 314 and an ending point 315 of the horizontal movement. Also, coordinates with a circulation angle=0 degree are coordinates of the ending point 315. The gesture determination unit 143 finds a circulation angle 311 between touch coordinates 316 of the pointer and the ending point 315. Then, if the circulation angle 311 is equal to or larger than the predefined circulation angle, the gesture determination unit 143 determines an amount of increase=1. Also, if the circulation angle 311 is equal to or larger than double the predefined circulation angle, the gesture determination unit 143 determines an amount of increase=2. The gesture determination unit 143 can also determine an amount of decrease with a similar procedure. Also, as the circulation angle 311 increases, the gesture determination unit 143 may specify an amount of increase not in proportion to the circulation angle 311 but in proportion to the second power of the circulation angle 311.

### Embodiment 3

In the rotation gesture according to Embodiment 1 and Embodiment 2, with the center position of the circle being shifted, there is a possibility that the gesture determination unit 143 becomes unable to accurately identify the amount of increase or the amount of decrease.

Thus, in the present embodiment, as illustrated in FIG. 6, the gesture determination unit 143 estimates the center position of the circle from touch coordinates for each rotation gesture. Then, based on the estimated center position of the circle, the gesture determination unit 143 extracts a moving locus for each rotation gesture. In this manner, with the gesture determination unit 143 estimating the center position of the circle for each rotation gesture and using the estimated center position of the circle for extracting a moving locus in each rotation gesture, the moving locus in each rotation gesture can be accurately extracted. As a result, the gesture determination unit 143 can enhance the accuracy in identifying a controlled variable.

In the present embodiment, only the operation of the gesture determination unit 143 is different compared with Embodiment 1. A hardware configuration example of the control target device 10 and the portable device 11 is as illustrated in FIG. 1, and a functional configuration example of the portable device 11 is as illustrated in FIG. 2. Also, an operation flow of the portable device 11 is as illustrated in FIG. 21.

In the following, differences from Embodiment 1 are mainly described.

In the course of a rotation gesture of a first lap illustrated in FIG. 6, the gesture determination unit 143 repeats randomly selecting three points from the coordinates of the circumference and performing a computation for finding an equation of a circle from these three points, thereby estimating the center position of the circle in the rotation gesture of the first lap. For example, it can be thought that, in the rotation gesture of the first lap, the gesture determination unit 143 repeats the operation of selecting three points from the coordinates of the circumference and performing the above-described computation until a moving locus corresponding to a quarter of the circle to estimate the center position of the circle in the rotation gesture of the first lap. Then, based on the estimated center position of the circle, the gesture determination unit 143 extracts a moving locus of the remaining three-quarter of the circle of the rotation gesture of the first lap. The gesture determination unit 143 also performs a similar operation on a rotation gesture of a second lap and a rotation gesture of a third lap.

Note that the gesture determination unit 143 may use a scheme, other than the above-described scheme, that can find the center position of the circle. Also, in place of finding the center position for each rotation gesture, the gesture determination unit 143 may find the center position of the circle at every specific interval (for example, at every interval in time or at every interval in touch coordinates).

### Embodiment 4

In the rotation gesture according to Embodiment 1 and Embodiment 2, it is difficult for the user to accurately render a perfect circle with the pointer.

Thus, in the present embodiment, an example is described in which the gesture determination unit 143 extracts a moving locus of a rotation gesture with reference to the rotation gesture model information.

In the present embodiment, only the operation of the gesture determination unit 143 is different compared with Embodiment 1. A hardware configuration example of the control target device 10 and the portable device 11 is as illustrated in FIG. 1, and a functional configuration example of the portable device 11 is as illustrated in FIG. 2. Also, an operation flow of the portable device 11 is as illustrated in FIG. 21.

In the following, differences from Embodiment 1 are mainly described.

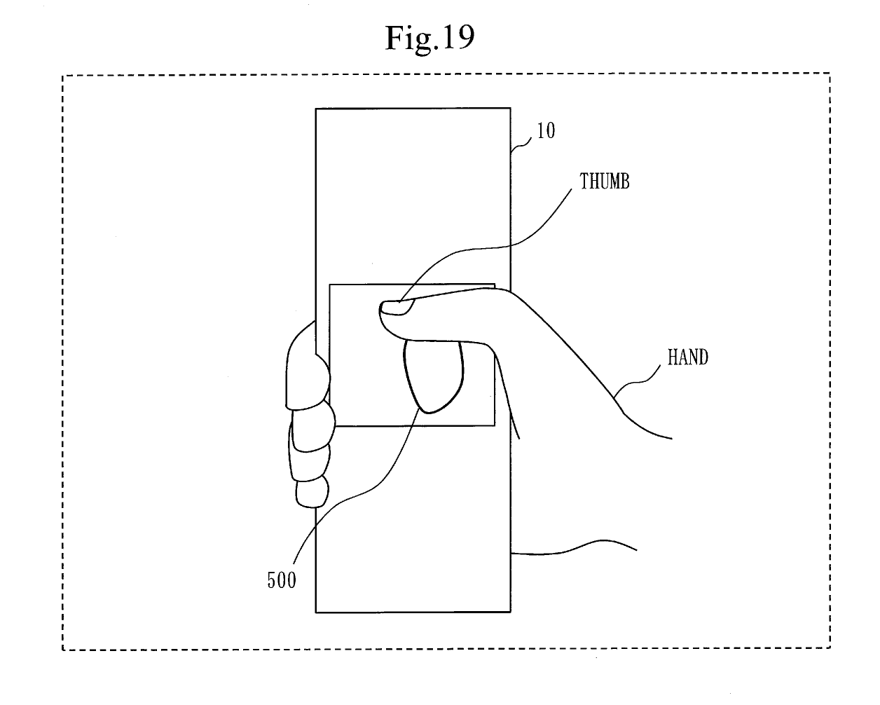

The rotation gesture model information storage unit 155 stores the rotation gesture model information. The rotation gesture model information indicates, for example, a model of a moving locus of a circular movement in a rotation gesture acquired by sampling. More specifically, the rotation gesture model information indicates a moving locus of a distorted circle 500 illustrated in FIG. 19. FIG. 19 represents that the distorted circle 500 has been rendered as a result of a rotation gesture by the user with the thumb.

The moving locus indicated in the rotation gesture model information may be a moving locus of an average circle selected from circles rendered by various users, or may be a moving locus of a circle rendered by the user of the portable device 11. Also, without preparation of rotation gesture model information in advance, the gesture determination unit 143 may learn a moving locus of a circle rendered by the user every time the user makes a rotation gesture and generate rotation gesture model information.

If the moving locus of the distorted circle 500 of FIG. 19 is registered as rotation gesture model information in the rotation gesture model information storage unit 155, even if a circle rendered by the user on the touch panel 118 to control the control target device 10 is distorted, the gesture determination unit 143 can recognize, by pattern matching, the moving locus of the distorted circle rendered on the touch panel 118 as a moving locus of a circular movement in a rotation gesture. As a result, the gesture determination unit 143 can enhance the accuracy in identifying a controlled variable.

Also, when the portable device 11 is shared by a plurality of users, the rotation gesture model information storage unit 155 may store the rotation gesture model information for each user. In this case, the gesture determination unit 143 reads rotation gesture model information corresponding to the user using the portable device 11 from the rotation gesture model information storage unit 155, and extracts a moving locus of the rotation gesture by using the read rotation gesture model information.

### Embodiment 5

In Embodiment 4, the example has been described in which the gesture determination unit 143 applies the rotation gesture model information to the rotation gesture of Embodiment 1. The gesture determination unit 143 may extract a moving locus of the circular movement by applying the rotation model gesture information also to the rotation gesture of Embodiment 2. That is, in the present embodiment, the gesture determination unit 143 extracts a moving locus of the circular movement by applying the rotation gesture model information to the distorted circle rendered on the touch panel 118 by the user to control the control target device 10, and specifies the circulation angle 311 illustrated in FIG. 5.

Also in the present embodiment, only the operation of the gesture determination unit 143 is different compared with Embodiment 1. A hardware configuration example of the control target device 10 and the portable device 11 is as illustrated in FIG. 1, and a functional configuration example of the portable device 11 is as illustrated in FIG. 2. Also, an operation flow of the portable device 11 is as illustrated in FIG. 21.

### Embodiment 6

In Embodiment 1, as illustrated in FIG. 3 and FIG. 4, the example has been described in which the parameter-specifying gesture is configured of one slide gesture.

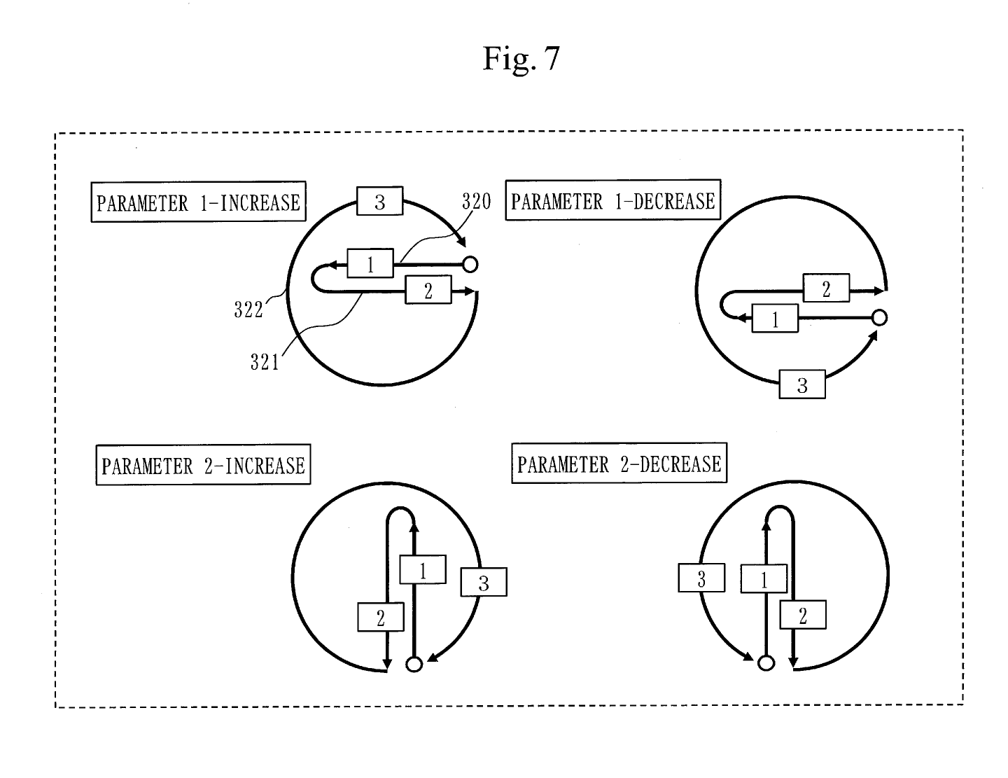

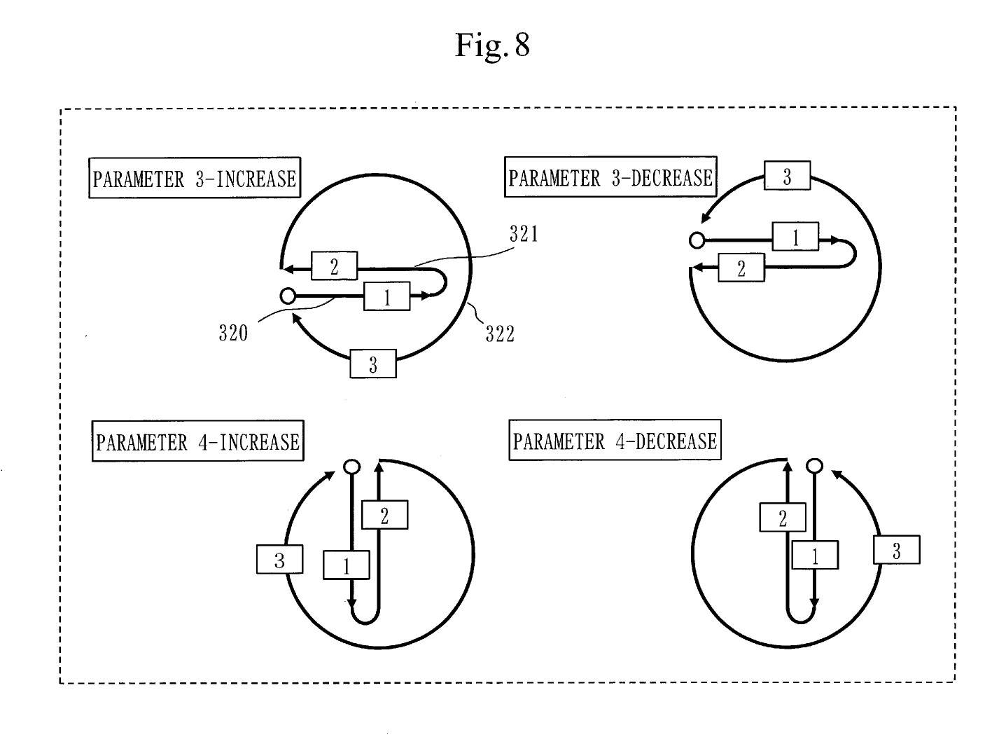

In place of this, as illustrated in FIG. 7 and FIG. 8, the parameter-specifying gesture may be configured of a combination of two slide gestures, a slide gesture 320 and a slide gesture 321. Also in an example of FIG. 7, the slide gestures 320, the slide gesture 321, and a rotation gesture 322 are made with one touch panel operation.

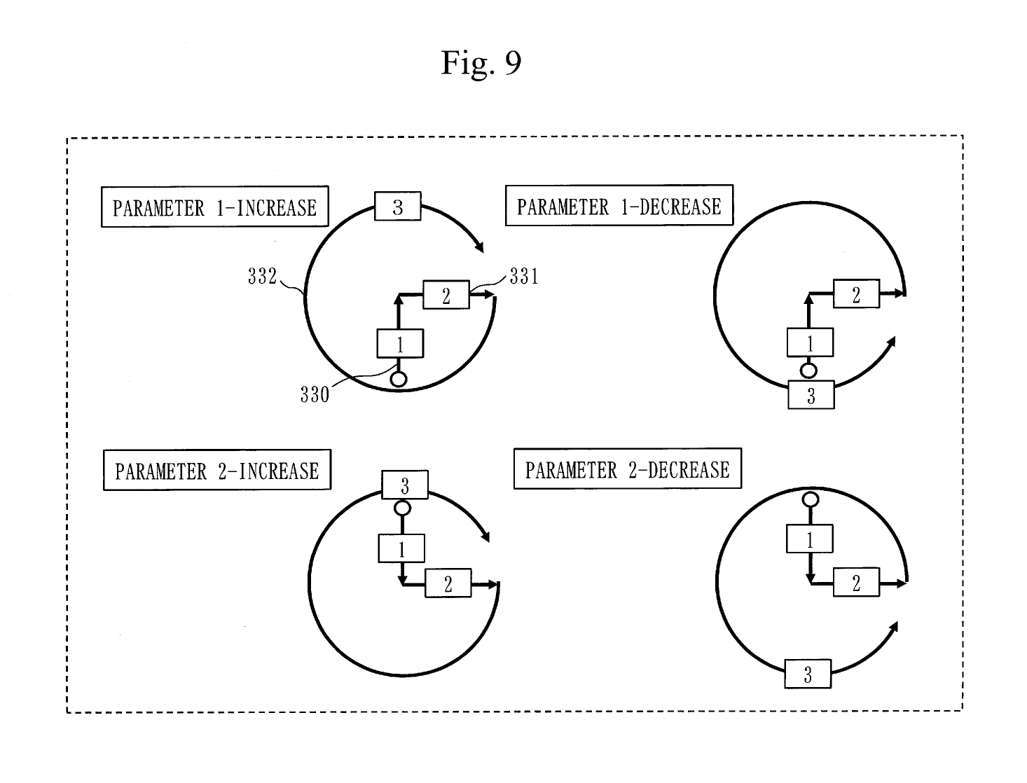

Also, as illustrated in FIG. 9, the parameter-specifying gesture may be configured of a combination of two slide gestures, a slide gesture 330 and a slide gesture 331. Also in an example of FIG. 9, the slide gestures 330, the slide gesture 331, and a rotation gesture 332 are made with one touch panel operation.

In this manner, in the present embodiment, the gesture determination unit 143 extracts moving loci of a plurality of linear movements as parameter-specifying moving loci, and identifies the control target parameter by analyzing the extracted moving loci of the plurality of linear movements.

Note that also in the present embodiment, only the operation of the gesture determination unit 143 is different compared with Embodiment 1. A hardware configuration example of the control target device 10 and the portable device 11 is as illustrated in FIG. 1, and a functional configuration example of the portable device 11 is as illustrated in FIG. 2. Also, an operation flow of the portable device 11 is as illustrated in FIG. 21.

### Embodiment 7

In Embodiments 1 to 6, the controlled-variable-specifying gesture is a rotation gesture.

In place of this, the controlled-variable-specifying gesture may be a slide gesture.

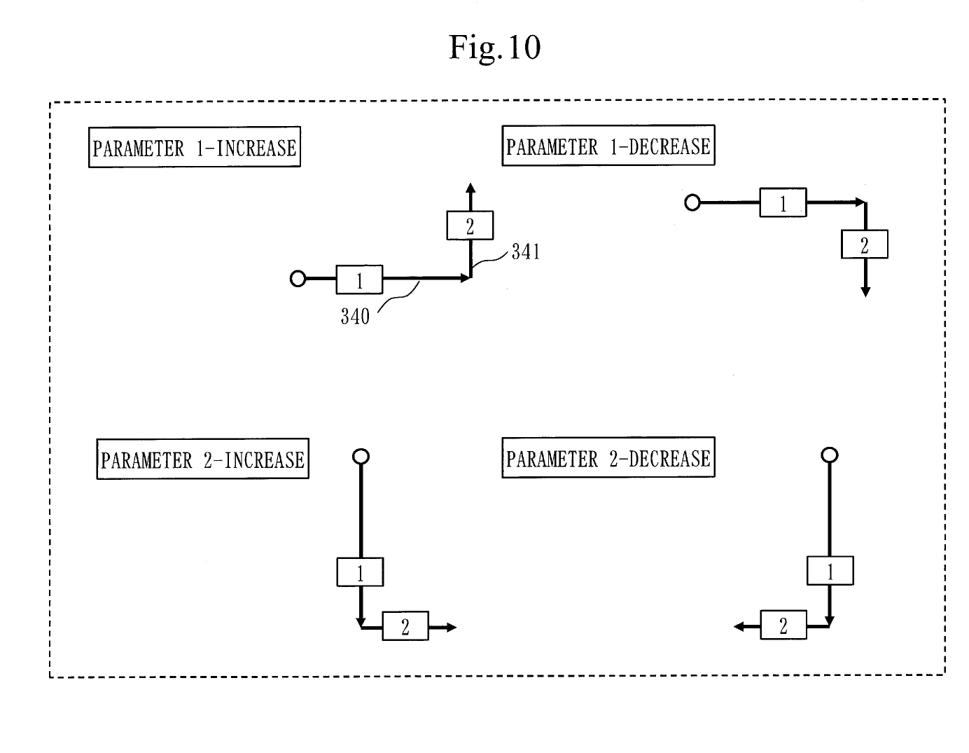

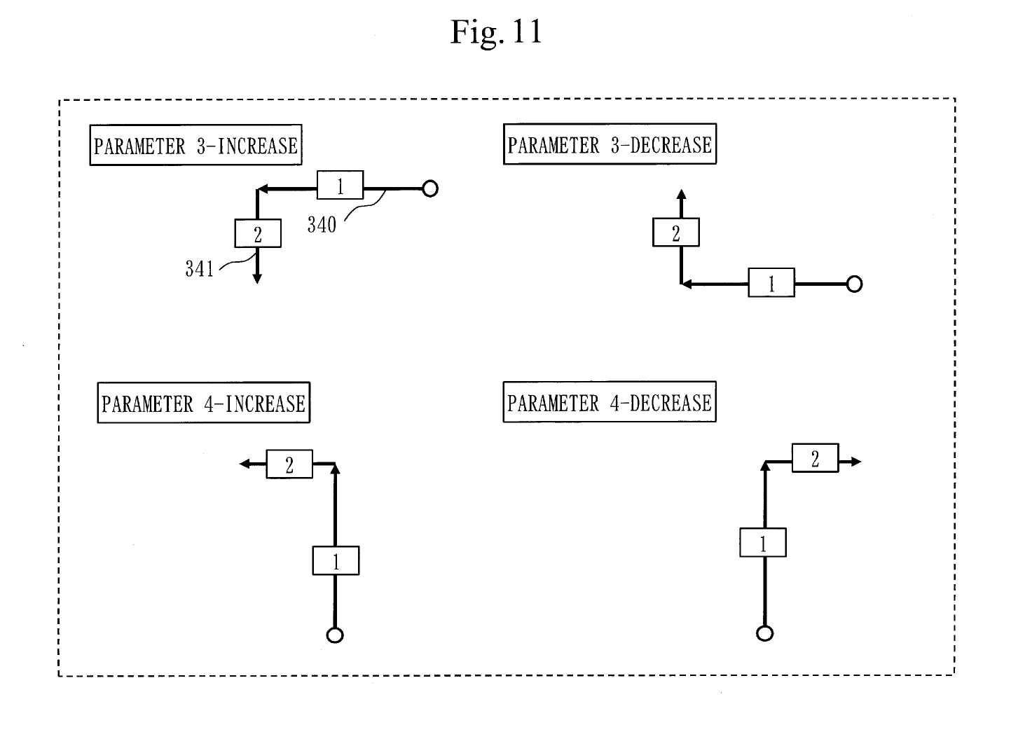

For example, as illustrated in FIG. 10 and FIG. 11, the parameter-specifying gesture may be configured of a slide gesture 340 and the controlled-variable-specifying gesture may be configured of a slide gesture 341. In this manner, in the present embodiment, the gesture determination unit 143 extracts a moving locus of a linear movement of the pointer as a parameter-specifying moving locus and a moving locus of another linear movement of the pointer as a controlled-variable-specifying moving locus.

Note that also in the present embodiment, only the operation of the gesture determination unit 143 is different compared with Embodiment 1. A hardware configuration example of the control target device 10 and the portable device 11 is as illustrated in FIG. 1, and a functional configuration example of the portable device 11 is as illustrated in FIG. 2. Also, an operation flow of the portable device 11 is as illustrated in FIG. 21.

### Embodiment 8

In Embodiment 1, as illustrated in FIG. 3 and FIG. 4, the example has been described in which a rotation gesture so as to surround a moving locus of a slide gesture in a horizontal direction is taken as a controlled-variable-specifying gesture.

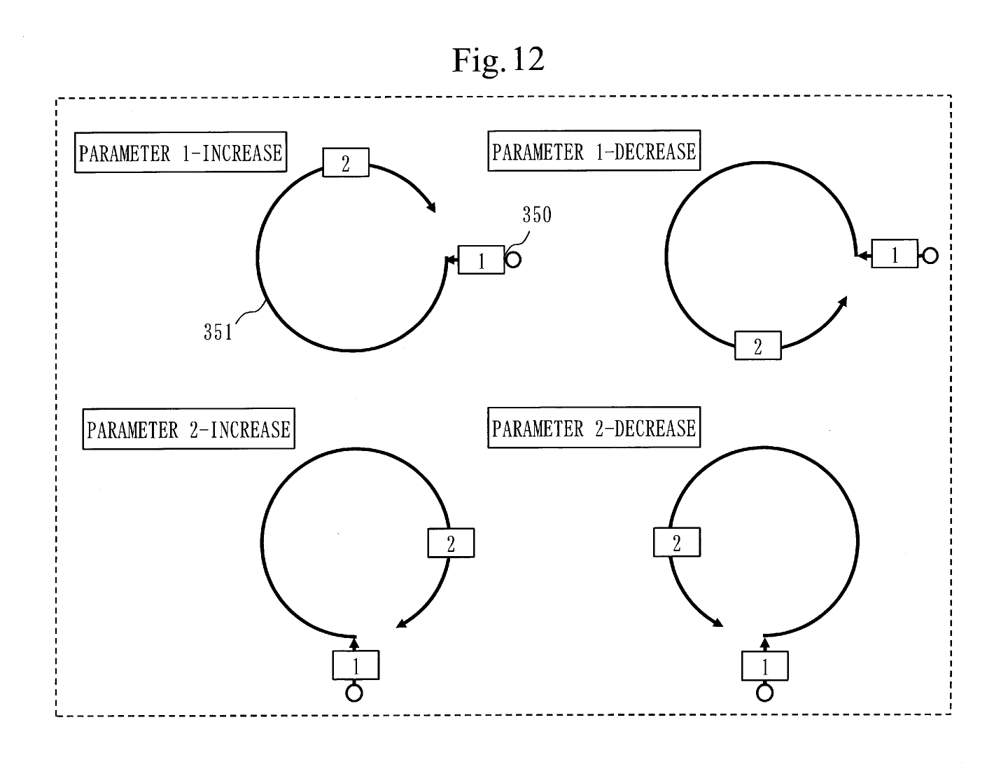

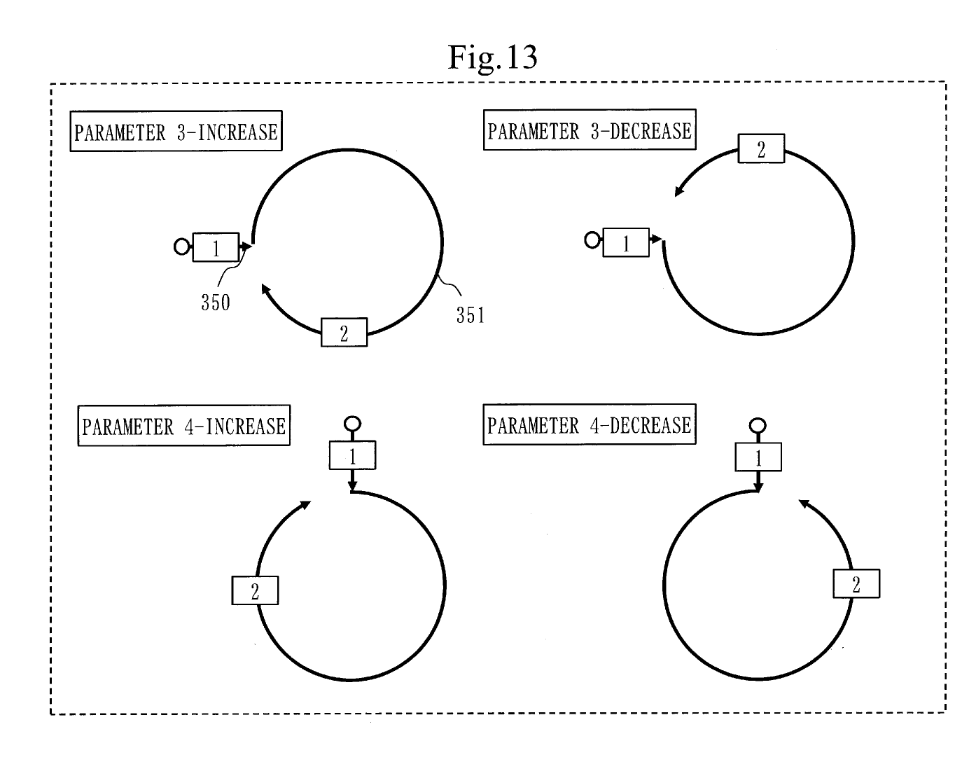

In place of this, as illustrated in FIG. 12 and FIG. 13, a rotation gesture 351 performed outside a slide gesture 350 of a horizontal movement may be taken as a controlled-variable-specifying gesture.

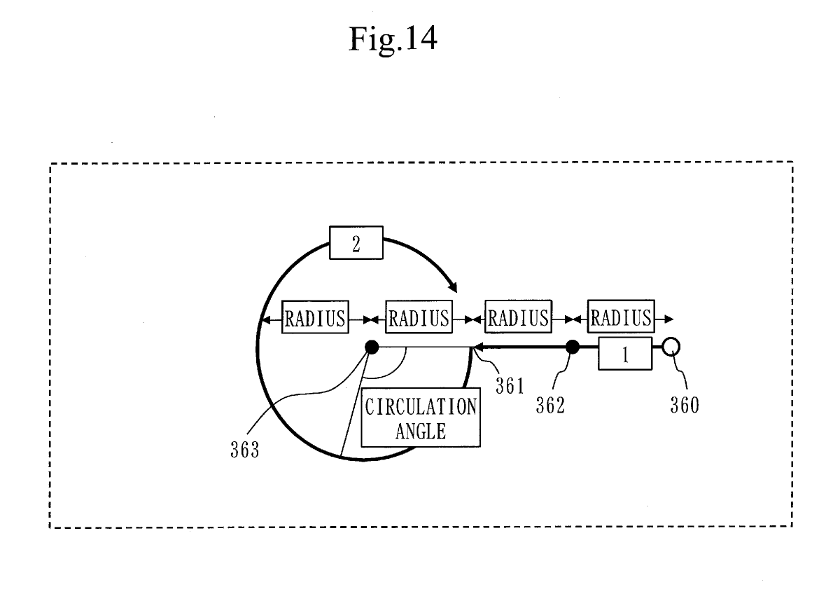

In the present embodiment, the gesture determination unit 143 finds the center of a circle of a rotation gesture with a method illustrated in FIG. 14.

That is, the gesture determination unit 143 finds a distance from a starting point 360 to an ending point 361 of a slide gesture. Next, the gesture determination unit 143 finds a center position 362 of the distance from the starting point 360 to the ending point 361. Next, the gesture determination unit 143 sets a center 363 of the circle at a position with the same distance as the distance from the center position 362 to the ending point 361.

When the slide gesture and the rotation gesture illustrated in FIG. 12 and FIG.

13 are used, as with Embodiment 2, if the user specifies a controlled variable with a circulation angle of the pointer in a rotation gesture, the gesture determination unit 143 calculates the circulation angle with reference to the center position 362 found in the method illustrated in FIG. 14.

Also in the present embodiment, only the operation of the gesture determination unit 143 is different compared with Embodiment 1. A hardware configuration example of the control target device 10 and the portable device 11 is as illustrated in FIG. 1, and a functional configuration example of the portable device 11 is as illustrated in FIG. 2. Also, an operation flow of the portable device 11 is as illustrated in FIG. 21.

### Embodiment 9

In Embodiments 1 to 8, the gesture determination unit 143 identifies a controlled variable by analyzing a rotation gesture with one pointer.

In place of this, the gesture determination unit 143 may identify a controlled variable by analyzing rotation gestures with a plurality of pointers.

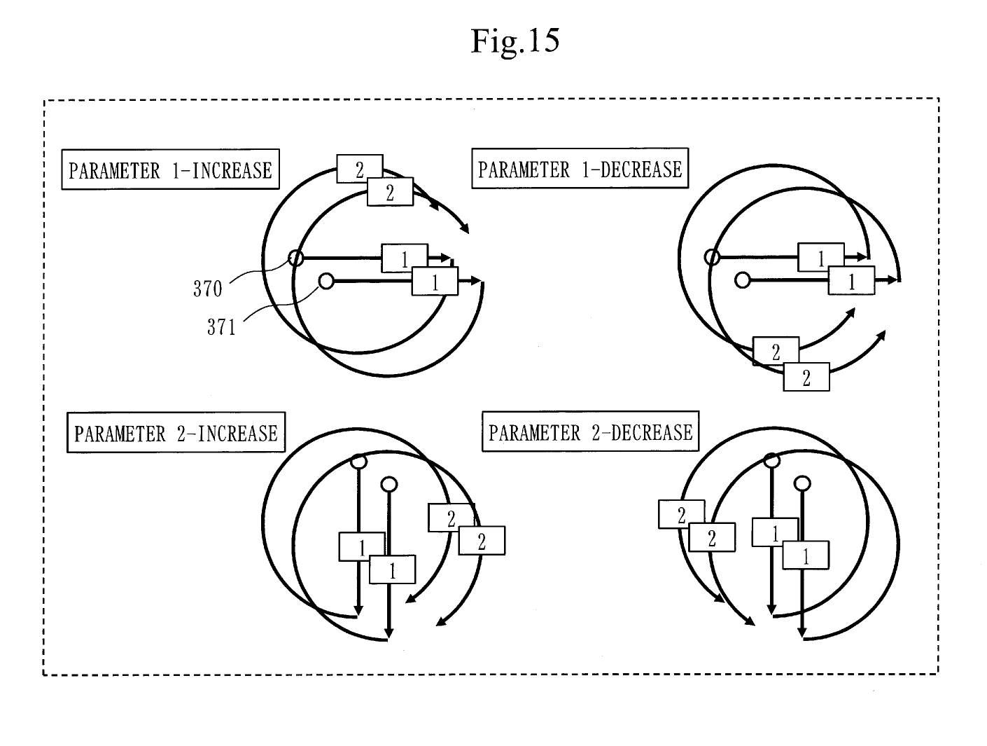

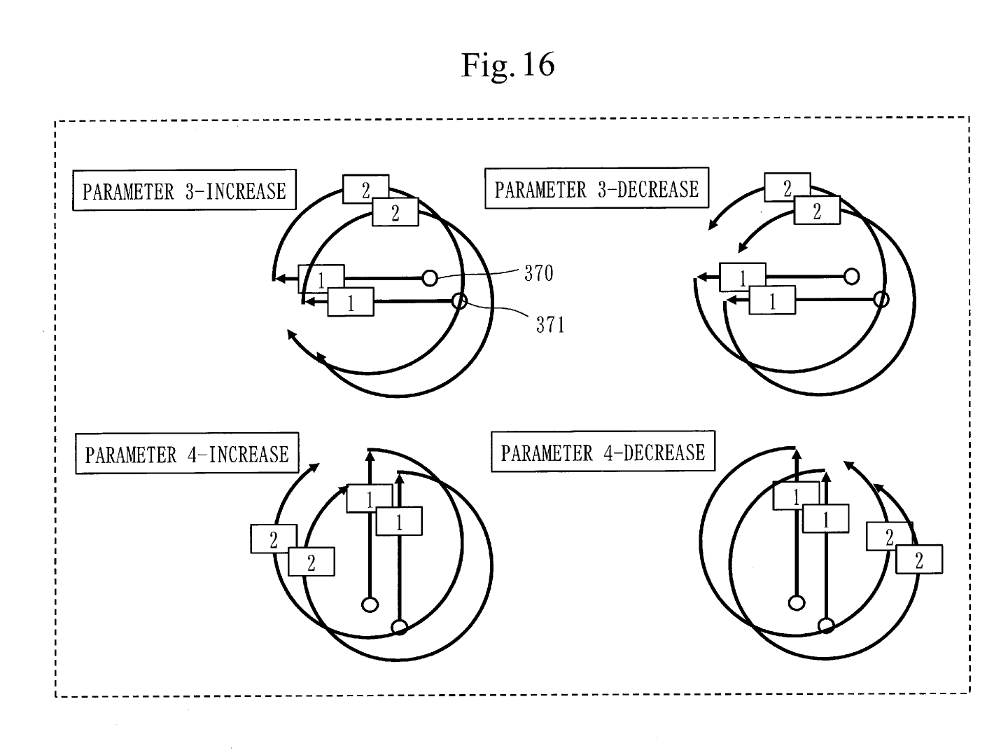

That is, as illustrated in FIG. 15 and FIG. 16, the gesture determination unit 143 according to the present embodiment identifies a controlled variable specified by the user by analyzing rotation gestures of two channels, gestures 370 and 371, acquired with two pointers simultaneously in contact with the touch panel 118.

In the examples of FIG. 15 and FIG. 16, the gesture determination unit 143 increments the amount of increase (or the amount of decrease) by two for each rotation gesture once.

That is, when n (n≥2) pointers are used, the gesture determination unit 143 increments the amount of increase (or the amount of decrease) by n for each rotation gesture once.

Also, the gesture determination unit 143 may increment the amount of increase (or the amount of decrease) by one for each rotation gesture once even when a rotation gesture is made with two pointers.

Also, when rotation gestures are made with two pointers after a slide gesture is made with one pointer, the gesture determination unit 143 may increment the amount of increase (or the amount of decrease) by two for each rotation gesture once.

Also in the present embodiment, since two rotation gestures are simultaneously made, circles rendered by the rotation gestures tend to be distorted. Thus, the gesture determination unit 143 may recognize rotation gestures by using the rotation gesture model information described in Embodiment 4.

In this manner, the gesture determination unit 143 according to the present embodiment extracts moving loci of a plurality of pointers and identifies a controlled variable by analyzing the moving loci of the plurality of pointers.

Note that also in the present embodiment, only the operation of the gesture determination unit 143 is different compared with Embodiment 1. A hardware configuration example of the control target device 10 and the portable device 11 is as illustrated in FIG. 1, and a functional configuration example of the portable device 11 is as illustrated in FIG. 2. Also, an operation flow of the portable device 11 is as illustrated in FIG. 21.

### Embodiment 10

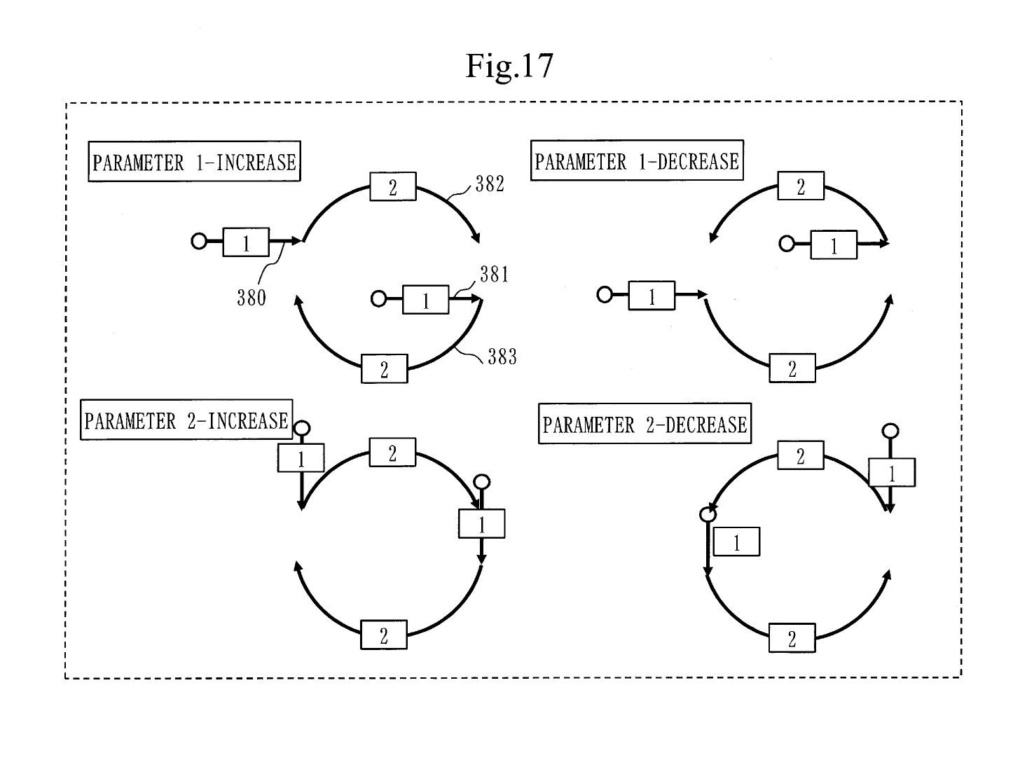

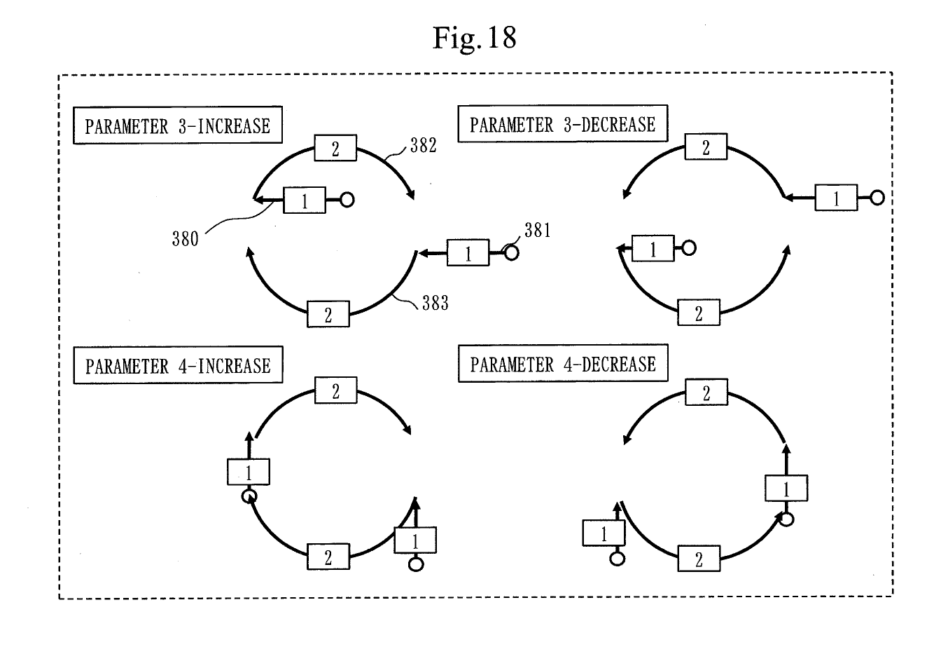

In Embodiment 9, the example has been described in which rotation gestures of Embodiment 1 are made with two pointers. The rotation gestures of Embodiment 2 may be made with two pointers. In the present embodiment, as illustrated in FIG. 17 and FIG. 18, the gesture determination unit 143 extracts moving loci of circular movements of rotation gestures made in parallel by two pointers simultaneously touching the touch panel 118, and identifies a controlled variable. In the present embodiment, after recognizing two parallel two slide gestures, the gesture determination unit 143 recognizes two rotation gestures 382 and 383. The gesture determination unit 143 identifies a controlled variable from the circulation angles of the pointers in the two rotation gestures 382 and 383.

In the present embodiment, since two rotation gestures are simultaneously made, circles rendered by the rotation gestures tend to be distorted. Thus, the gesture determination unit 143 may recognize rotation gestures by using the rotation gesture model information described in Embodiment 4.

Also in the present embodiment, only the operation of the gesture determination unit 143 is different compared with Embodiment 1. A hardware configuration example of the control target device 10 and the portable device 11 is as illustrated in FIG. 1, and a functional configuration example of the portable device 11 is as illustrated in FIG. 2. Also, an operation flow of the portable device 11 is as illustrated in FIG. 21.

### Embodiment 11

In Embodiment 1, the gesture determination unit 143 identifies a controlled variable by the circulation count of the pointer in a rotation gesture. However, the orientation of the portable device 11 is fixed in Embodiment 1.

That is, in Embodiment 1, the gesture determination unit 143 cannot correctly recognize the parameter-specifying gesture when the portable device 11 is held in an orientation reverse to a normal orientation.

In the present embodiment, by utilizing the gravity sensor 113 illustrated in FIG. 1, the gesture determination unit 143 can correctly recognize the parameter-specifying gesture even if the portable device 11 is reversely held.

More specifically, in the present embodiment, the gesture determination unit 143 identifies a control target parameter and a controlled variable based on the moving locus of the pointer and the direction of the portable device 10 acquired from the measurement result of the gravity sensor.

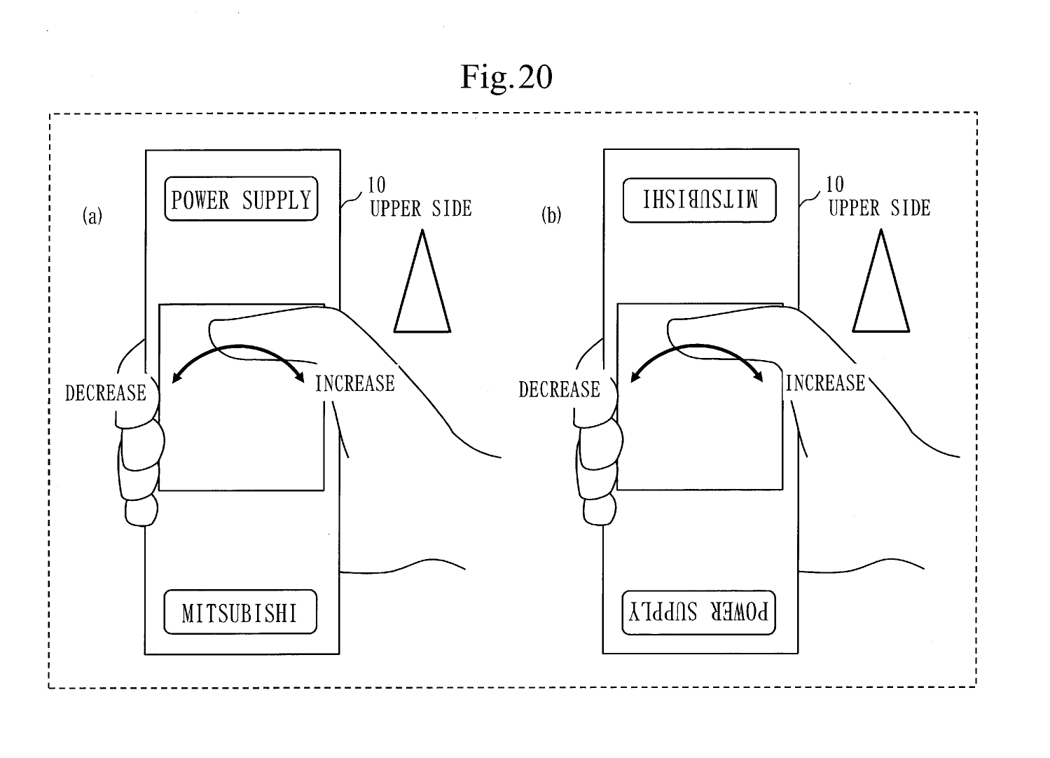

In the present embodiment, before a gesture is made by the user, the direction detection unit 147 acquires the measurement result of the gravity sensor 113, and determines a top-and-bottom direction of 11 of the portable device by using the measurement result of the gravity sensor 113. Then, the gesture determination unit 143 calculates touch coordinates acquired from the touch panel 118 via the touch coordinate acquisition unit 142 in accordance with the top-and-bottom direction of the portable device 11 determined by the direction detection unit 147. With this, as illustrated in FIG. 20, the gesture determination unit 143 can correctly recognize a rotation gesture and identify a correct controlled variable even if the portable device 11 is held in the normal orientation ((a) of FIG. 20) and the portable device 11 is held in the reverse orientation ((b) of FIG. 20).

Also in the present embodiment, only the operation of the gesture determination unit 143 and the direction detection unit 147 is different compared with Embodiment 1. A hardware configuration example of the control target device 10 and the portable device 11 is as illustrated in FIG. 1, and a functional configuration example of the portable device 11 is as illustrated in FIG. 2. Also an operation flow of the portable device 11 is as illustrated in FIG. 21.

While the embodiments of the present invention have been described in the foregoing, two or more of these embodiments may be combined and implemented.

Alternatively, one of these embodiments may be partially implemented.

Alternatively, two or more of these embodiments may be partially combined and implemented.

Note that the present invention is not limited to these embodiments and can be variously modified as required.

***Description of Hardware Configuration***

Finally, supplemental description of the hardware configuration of the portable device 11 is made.

The processor 111 illustrated in FIG. 1 is an IC (Integrated Circuit) which performs processing.

The processor 111 is a CPU (Central Processing Unit), DSP (Digital Signal Processor), or the like.

The communication interface 110 is, for example, a communication chip or NIC (Network Interface Card).

An OS (Operating System) is also stored in the ROM 116.

And, at least part of the OS is executed by the processor 111.

While executing at least part of the OS, the processor 111 executes programs for realizing the functions of the communication processing unit 140, the gesture detection unit 141, the sensor unit 146, and the display control unit 150 (these are hereinafter collectively referred to as “units”).

With the processor 111 executing the OS, task management, memory management, file management, communication control, and so forth are performed.

While one processor is illustrated in FIG. 1, the portable device 11 may include a plurality of processors.

Also, information, data, a signal value, and a variable value indicating the results of processes by the “unit” are stored at least any of the RAM 117 and a register and a cache memory in the processor 111.

Also, the programs for achieving the functions of the “units” may be stored in a portable storage medium such as a magnetic disk, flexible disk, optical disk, compact disk, Blu-ray (a registered trademark) disk, or DVD.

Also, the “units” may be read as “circuits”, “steps”, “procedures”, or “processes”.

Also, the portable device 11 may be realized by an electronic circuit such as a logic IC (Integrated Circuit), GA (Gate Array), ASIC (Application Specific Integrated Circuit), or FPGA (Field-Programmable Gate Array).

In this case, each of the “units” is realized as part of the electronic circuit.

Note that the processor and the above electronic circuits are also collectively referred to as processing circuitry.

### REFERENCE SIGNS LIST

10: control target device; 11: portable device; 101: communication interface; 102: processor; 103: output apparatus; 110: communication interface; 111: processor; 112: sensor unit; 113: gravity sensor; 114: touch sensor; 115: FPD; 116: ROM; 117: RAM; 118: touch panel; 140: communication processing unit; 141: gesture detection unit; 142: touch coordinate acquisition unit; 143: gesture determination unit; 146: sensor unit; 147: direction detection unit; 148: touch detection unit; 150: display control unit; 153: allocation information storage unit; 155: rotation gesture model information storage unit

1-13. (canceled)

14. An information processing apparatus including a touch panel, the information processing apparatus comprising:
processing circuitry to:
extract a moving locus of a pointer from a time when the pointer makes contact with the touch panel until the pointer goes away from the touch panel; and
extract from the moving locus of the pointer, a moving locus specifying a control target parameter, which is a parameter of a control target, as a parameter-specifying moving locus, and extract a moving locus specifying a controlled variable of the control target parameter as a controlled-variable-specifying moving locus, by analyzing the moving locus of the pointer extracted, identify the control target parameter by analyzing the extracted parameter-specifying moving locus, and identify the controlled variable by analyzing the extracted controlled-variable-specifying moving locus.

15. The information processing apparatus according to claim 14, wherein
the processing circuitry
extracts a moving locus of a linear movement of the pointer as the parameter-specifying moving locus and extracts a moving locus of a circular movement of the pointer as the controlled-variable-specifying moving locus, from the moving locus of the pointer extracted,
identifies the control target parameter by analyzing the extracted moving locus of the linear movement, and
identifies the controlled variable by analyzing the extracted moving locus of the circular movement.

16. The information processing apparatus according to claim 15, wherein
the processing circuitry identifies the control target parameter by analyzing a position of a starting point and a position of an ending point of the linear movement.

17. The information processing apparatus according to claim 15, wherein
the processing circuitry identifies the controlled variable by analyzing a circulation direction and a circulation count of the pointer in the moving locus of the circular movement.

18. The information processing apparatus according to claim 15, wherein
the processing circuitry estimates a center position of a circle in the circular movement, and extracts the moving locus of the circular movement based on the estimated center position of the circle.

19. The information processing apparatus according to claim 15, wherein
the processing circuitry extracts the moving locus of the circular movement from the moving locus of the pointer extracted with reference to a model of the moving locus of the circular movement.

20. The information processing apparatus according to claim 15, wherein
the processing circuitry
extracts moving loci of a plurality of linear movements as the parameter-specifying moving loci, and
identifies the control target parameter by analyzing the extracted moving loci of the plurality of linear movements.

21. The information processing apparatus according to claim 14, wherein
the processing circuitry extracts a moving locus of a linear movement of the pointer as the parameter-specifying moving locus, and extracts a moving locus of another linear movement of the pointer as the controlled-variable-specifying moving locus.

22. The information processing apparatus according to claim 14, wherein
the processing circuitry extracts moving loci of a plurality of pointers, and identifies the controlled variable by analyzing the moving loci of the plurality of pointers extracted.

23. An information processing method comprising:
by a computer including a touch panel, extracting a moving locus of a pointer from a time when the pointer makes contact with the touch panel until the pointer goes away from the touch panel; and
by the computer, extracting from the moving locus of the pointer, a moving locus specifying a control target parameter, which is a parameter of a control target, as a parameter-specifying moving locus, and extracting a moving locus specifying a controlled variable of the control target parameter as a controlled-variable-specifying moving locus, by analyzing the extracted moving locus of the pointer, identifying the control target parameter by analyzing the extracted parameter-specifying moving locus, and identifying the controlled variable by analyzing the extracted controlled-variable-specifying moving locus.

24. A non-transitory computer readable medium storing an information processing program that causes a computer including a touch panel to execute:
an extraction process of extracting a moving locus of a pointer from a time when a pointer makes contact with the touch panel until the pointer goes away from the touch panel; and
an identification process of extracting from the moving locus of the pointer, a moving locus specifying a control target parameter, which is a parameter of a control target, as a parameter-specifying moving locus, and extracting a moving locus specifying a controlled variable of the control target parameter as a controlled-variable-specifying moving locus, by analyzing the moving locus of the pointer extracted by the extraction process, identifying the control target parameter by analyzing the extracted parameter-specifying moving locus, and identifying the controlled variable by analyzing the extracted controlled-variable-specifying moving locus.
